(19) United States
(12) Patent Application Publication
(10) Pub. No.: US 2007/0264607 A1
(43) Pub. Date: Nov. 15, 2007

(54) System and process for three dimensional teeth movements using a spring retained device attached to an orthodontic micro implant

(76) Inventor: Oscar Olavarria Landa, Caracas (VE)

Correspondence Address: LADAS & PARRY, 26 WEST 61ST STREET, NEW YORK, NY, 10023, US

(21) Appl. No.: 11/431,906

(22) Filed: May 10, 2006

(51) Int. Cl. A61C 3/00

(52) U.S. Cl. 433/18

(57) ABSTRACT

Device designed to be used as an instrument for moving teeth three dimensionally; it is anchored on an Orthodontic Micro Implant which such head was also designed perfectly to couple with the attachment on the head of the micro implant. The system is composed by two parts: (a), or anchorage part, which is the Orthodontic Micro Implant having a octagonal head with a channel in the middle portion around the micro implant head, also octagonal shaped internally in order to receive the attachment or (b) which will perform the biomechanical action for moving teeth in a desire direction. Part b, is a series of devices which will be the active part of the system, and it has a “C” clasp portion on the base, octagonal shaped internally in order to match or couple with the also octagonal head groove of the implant head will act as retentive segment; and a finger spring with different designs is attached to the “C” Clasp base with some helixes for more spring back action.

### FIELD OF INVENTION

There is provided a device and process for use to move teeth three dimensionally. To achieve intrusion of teeth, eruption of impacted or retained teeth into the jaw bone, shortening the amount of time it usually takes; distal or mesial movements of teeth and also labial or lingual movements of teeth. All of them getting anchorage in bone.

This invention provides a surgical method using an Orthodontic Micro Implant as anchorage and a device attached to the micro implant's head that give to the clinician a perfect anchorage through the bone, in order to move teeth in tri dimensions.

This Invention tends to negate the third Physics Newton's Law having an anchor system on bone, resulting in no side effects as usually happen when we use other teeth for anchorage.

This Invention reduces the amount of orthodontic treatment time due to the constant force system applied and also since regular braces only will have to be set in place after we use this novice device. This also creates more comfort on patients.

This Invention provides an effective, safe and reliable method of moving teeth in three dimensions.

### BACKGROUND

It is well known that applying Orthodontic forces over the anchor teeth we will have some type of side effect over them. Since a long time, Orthodontists have been treating cases with many malocclusions problems needing to move teeth in many directions but having side effects like lost of anchorage, incomplete space closure, time consuming techniques among many others. Orthodontists have been dealing with impacted teeth which it has been a very difficult and challenging task to do. Other problem encountered is, that using elastomeric threads as a traditional method in order to move teeth into position, it is well known that the elastic threads tend to loose the amount of activation as the tooth start moving, taking more time the traction process thus the treatment time. In other words, there is a decreased power due to the fact that the amount of force it is not a constant force system. Also, it is known that many ways of anchorage have been reported on the literature but in all of them, anchorage have been set over already erupted teeth and over regular orthodontic braces. Lately, micro implants have been used as an anchorage appliance to move teeth. In many cases they are only used as anchorage indeed along with some elastic forces but not as a system where it has an anchorage component and an active component which will be in charge of creating the tooth movement as the one here proposed, in such which case the use of elastic threads makes it not a constant force system applied to a determined tooth or group of teeth. So, the herein proposed device will used the same anchorage system which is an Orthodontic Micro Implant, but having a new design costume made for receiving the attachment or Spring, which will perform the action of moving teeth but having a constant force system applied to the tooth to be moved.

With upcoming of the Orthodontics Micro Implants development and use, an anchor system have been developed negating the regular side effects of traditional anchorage on orthodontic braces. For these reasons, herein proposed Device composed by a “C” clasp, with an octagonal shape inside the retentive part, coupling with the also octagonal part of the head of the Orthodontic Micro Implant especially designed for matching it with such “C” clasp portion. The Clasp has as an active part, a finger spring which it is the extended portion of the wire which it will deliver the force system to move a tooth in a specific direction. This wire is attached in and over the “C” clasp base. This part will deliver a constant force system to the teeth to be moved.

Versatility of the present device allows the clinician to deliver traction to teeth in any direction due to the fact that being an octagonal head and coupling system, it can be inserted in many directions depending on which traction direction is more desirable to a specific tooth. It is a very important consideration that the force system applied to the implant with this device it is over the long axis of the implant, being very well resisted by implant itself.

In cases of when boarding a retained or impacted tooth which is usually having its crown imbedded into a bone area is to have in mind that the crown itself of such impacted tooth will not be able to reabsorb bone surrounding it if pull it laterally like in those cases of upper impacted canine on the palate side, due to the fact that peri coronary membrane is usually removed when surgical procedure is done. So, having this observation clear, once the tooth is exposed it will have to be pull out first, in order to have its crown clear in the patient mouth and then it would be ready to be moved towards its own place into the dental arch.

Also in cases where you find, a neumatized sinus where the patient does not have enough stability and a quality of bone for holding the implant, with the help of this device, implants can be placed where the implant will have sufficient bone surrounding it for such stability of the anchorage system. In such cases the use of the present system will help the clinicians to achieve a good anchorage place for mesial or distal movements of some teeth in order to get better occlusion.

A total of 9 different option designs are presented here of the Spring Retained Device: Option I: it has the finger spring attached to a “C” Clasp base, 4, having the helix zone, 5, located perpendicular in a 90° angle in relation to the “C” clasp base and a wire extension to be used for extrusion of teeth, 6. (FIGS. 2-3&4). Option II: it has the helix area, 5, in the same direction of the “C” clasp base, 4, being parallel and close to the head of the Micro Implant, a, and the wire extension, 6, is in opposite direction to the “C” clasp base, 4. (FIGS. 5&6) Option III: it is the same as option II but it is the counter part to be used in the other side of the maxilla or mandible when extrusion of teeth is needed. (FIGS. 7&8). Option IV: The “C” clasp, 4, is connected to an arm extension, 8, straight following the same axis, then a helix area, 5, is in the same plane of the “C” clasp base, 4, and the activation arm is at 90° angle. (FIGS. 9 & 10). This design as well as the Option II and III are used for extrusion of teeth when the Micro Implant is located laterally on the alveolar ridge between roots. Option V: it has the “C” clasp located in the same long axis of the first portion of the spring, 8, and then the helixes done in a counter clock direction, 5, are locate in the same plane of the “C” clasp, 4, and the extended wire portion at 45° angle in relation to the arm extension, 8. (FIGS. 11 & 12). This design works fine for intrusive force when the insertion of the device is done vertically and for mesial and distal movements when the insertion is done horizontally. With this version is important to add to the tooth surface some source of attachment bonded to the tooth surface to act as a stop. Option VI: On this design, the “C” clasp, 4, has an arm extension, 8, in a 90° angle and the helix area perpendicular to the “C” clasp base and the active portion of the spring also has 90° angle also perpendicular to the “C” clasp base. Option VII: On this design the “C” clasp, 4, and the arm extension, 8, are in the same axis locate, the helix area, 5, is horizontally oriented but perpendicular to it, and a double bend spring, 6, is made. This is used to move teeth labial lingually.

Option VIII: On this option, the “C” clasp base, 4, and the wire extension, 8, are in the same axis, but the helix portion, 5, is located perpendicular to the first portion of the spring, 8, forming a 90°, to the wire extension. Option IX: in this option we have a straight wire portion attached to the “C” clasp. This might let the clinician to create or adapt a costume made spring depending on the case

Step by Step Clinical Procedures

a) Anesthesia

b) Mark the position and correct direction of the micro implant to be placed.
In this step there is made a clinical and radiographic analysis where and in which direction the micro implant would have to be placed, taking into consideration direct clinical study of the anatomical structures surrounding the place to locate the screw, plus a detailed radiographic analysis of such structures and also of the study models.

c) Drilling for creation of a perforation that will allow to the micro screw to go into the bony structure.

d) Screwing procedure of the Orthodontic Micro Implant.

e) Insertion of the spring retained appliance into the head of the Micro Implant, taking care of the right direction for obtaining the desire tooth movement.

f) Activation of the spring by pulling the active arm towards the tooth to be moved and tightening with a simple piece of elastic or wire as desire.

### BRIEF DESCRIPTION OF THE DRAWINGS

FIG. 1 A is a lateral view of the Orthodontic Micro Implant and its design presented in this invention,

FIGS. 1 B and C are a perspective view of the Orthodontic Micro Implant and its design presented in this invention with its octagonal hex 1, octagonal head groove 2 and screw area 3.

FIG. 1 D is a top view of the head of the Orthodontic Micro Implant.

FIGS. 2 A, B, C, D and E are a perspective view of the device, part b of this invention: The Spring retained device with the “C” Clasp retentive part, 4, and the wire extension 6 which is the active portion of the present invention having some helix 5 for better spring back action. A helix made by the clinician at the tip of the spring depending on how long it wants it the arm to be, 7.

FIG. 3 is a perspective view of both parts of the System, a & b, presented on this invention. It shows how the C clasp base, 4, is inserted into the Micro Implant head groove 2.

FIG. 4 is a perspective view of this invention system in perfect coupling both parts a, and b.

FIGS. 5 and 6 is a plane view and a perspective view of the Option II for extrusion forces and its process for activation.

FIGS. 7 and 8 is a plane view and a perspective view of the Option III for extrusion forces and its process for activation, as counter part of Option II.

FIG. 9 is a perspective view of the option IV of this invention. In this case the C clasp is oriented on the same axis of the first part of the spring, 8, as well as the helixes area, 5, and the active part of the spring 6 is oriented 90° perpendicular to the retentive part or “C” clasp, 4.

FIG. 10 is a perspective view of the system with both parts coupling a, and b, using option IV and the way how it can be activated.

FIGS. 11 & 12: is a perspective view of the device Option V: it has the “C” clasp located in the same long axis of the first portion of the spring, 8, and then the helixes done in a counter clock direction, 5, are locate in the same plane of the “C” clasp, 4, and the extended wire portion at 45° angle in relation to the arm extension, 8. (FIGS. 11 & 12). This design works fine for intrusive force when the insertion of the device is done vertically and for mesial and distal movements when the insertion is done horizontally. With this version is important to add to the tooth surface some source of attachment bonded to the tooth surface to act as a stop. The “C” clasp portion with both parts coupling a, and b, using option II but with an inverted insertion of the device depending on the desire location and tooth movement.

FIG. 13 is a perspective view of the Option VI of this Invention. In this case the C clasp 4 is perpendicular oriented 90° to the first portion of the spring, 8; the helix area, 5, is also oriented 90° to the first part of the spring but perpendicular to the C clasp portion; and the active part of the spring is oriented following the helixes direction. In any case the end part of the active portion of the spring 7 always can be bent in order to have either a helix done or end up inside an attachment.

FIG. 14 is a perspective view of the Option VII of this Invention. In this case the “C” clasp, 4, is following the same axis of the first part of the spring, 8, then the helixes, 5, are perpendicular oriented 90° to the first portion of the spring, 8; the active part of the spring is oriented in the same axis of the helixes area. This option can be used for labial or lingual movements of teeth.

FIG. 15 is a perspective view of the device option VIII where the “C” clasp and the first part of the spring is in the same axis, the helix zone, 5, is perpendicular to the “C” clasp, and the active part is in 90°. This device works fine for mesial or distal movements.

FIG. 16 is a perspective view of the device option IX where there is a “C” clasp with a straight wire extension for the clinician to create its own design of the spring retained device.

FIG. 17 is a perspective view of option VI, A; option VII, B; and option VIII, C; with different device design working simulation.

FIG. 18 is a graphic view of the spring retained system working on 4 different situations: A) a lateral extrusive system working to extrude an impacted canine; B) is a graphic of an occlusal view of the spring retained device working on an upper impacted canine; C) is a graphic of an impacted lower first molar with the device working to extrude it; D) is a graphic of an upper extruded first molar that need to be level and intrude it. We can see the device working to intrude it.

FIG. 19 is a graphic view of the spring retained device working on 2 different option device: A) is a graphic of an upper arch with a first molar that need to be moved labially. The spring retained device is seen working to move it labially; B) is a graphic of an upper arch with a second molar that needs to be moved distally.

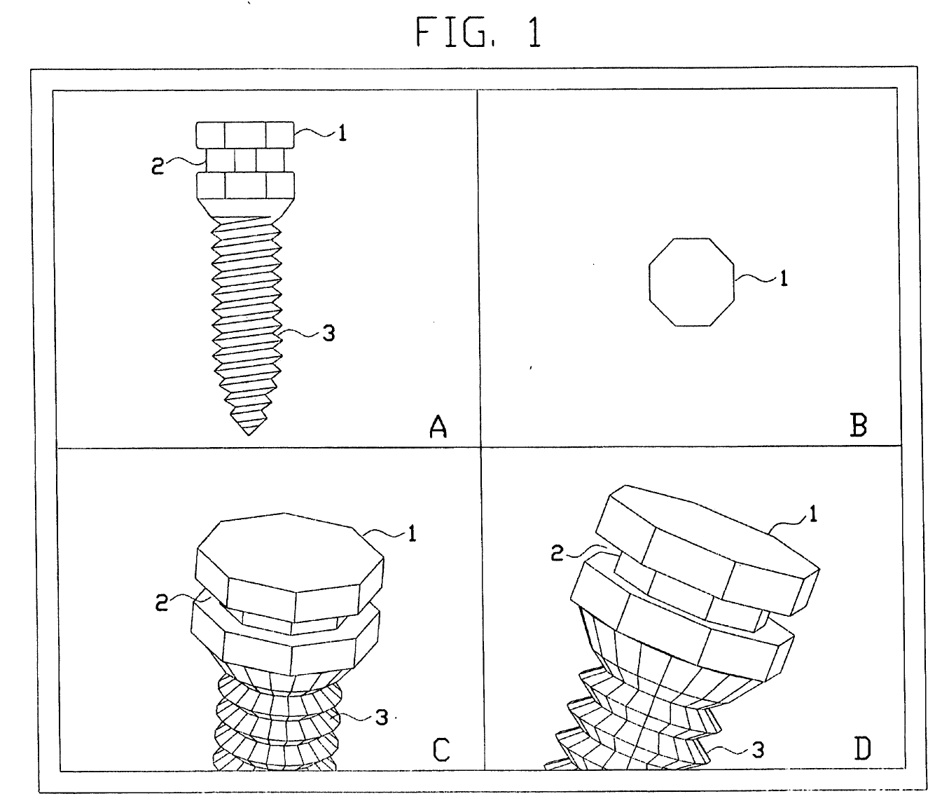

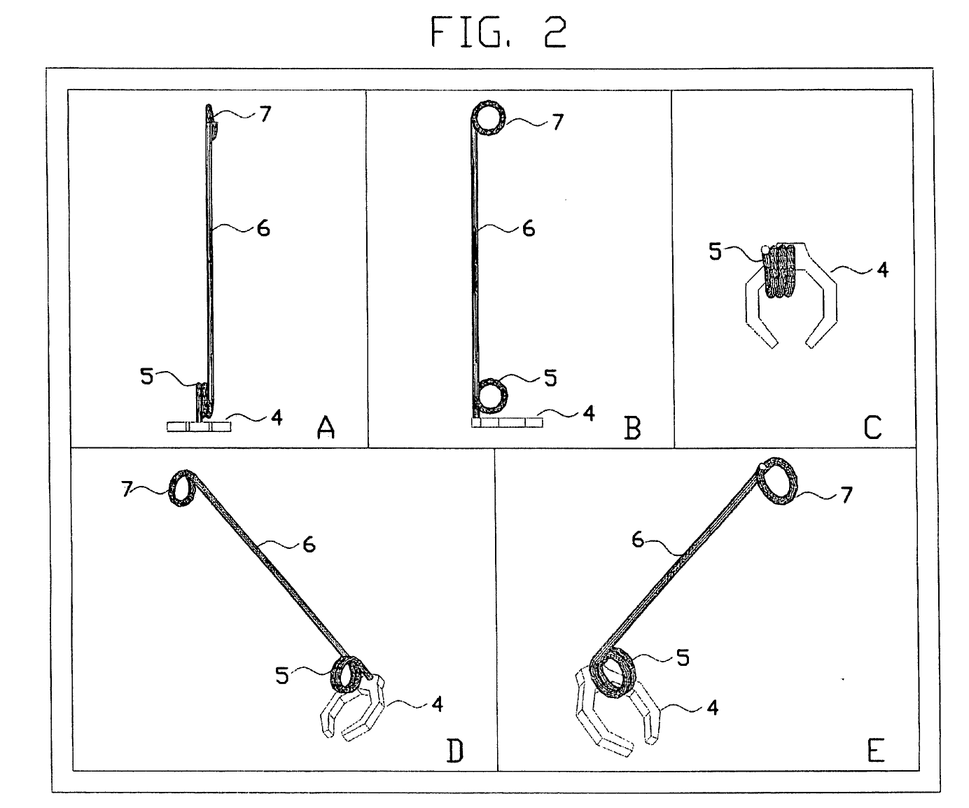

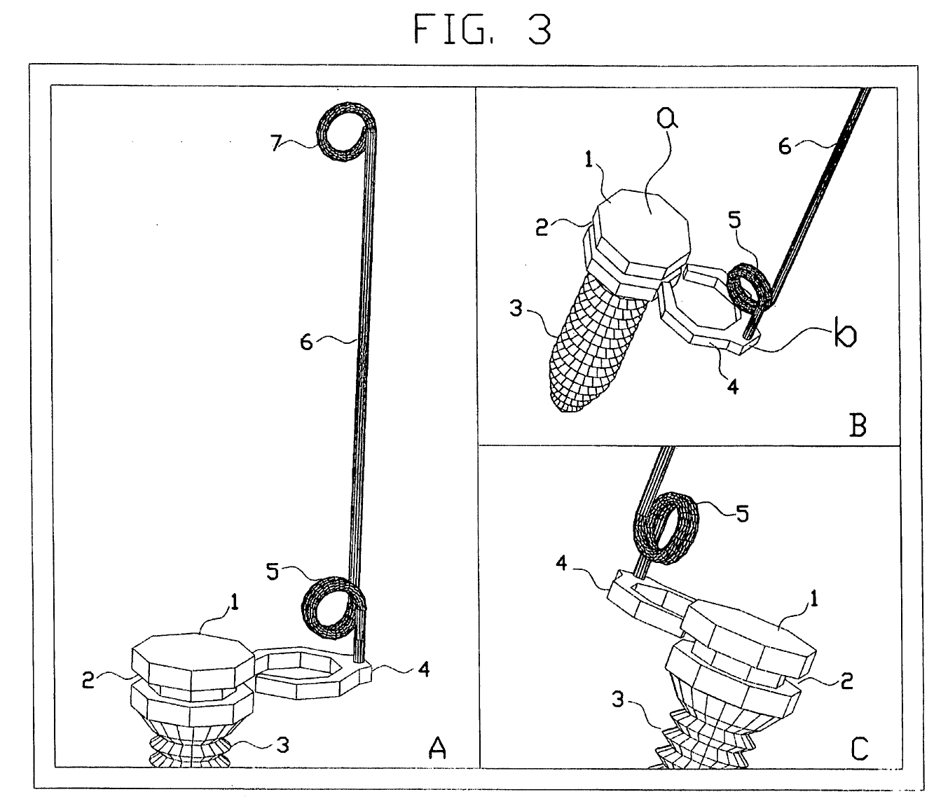

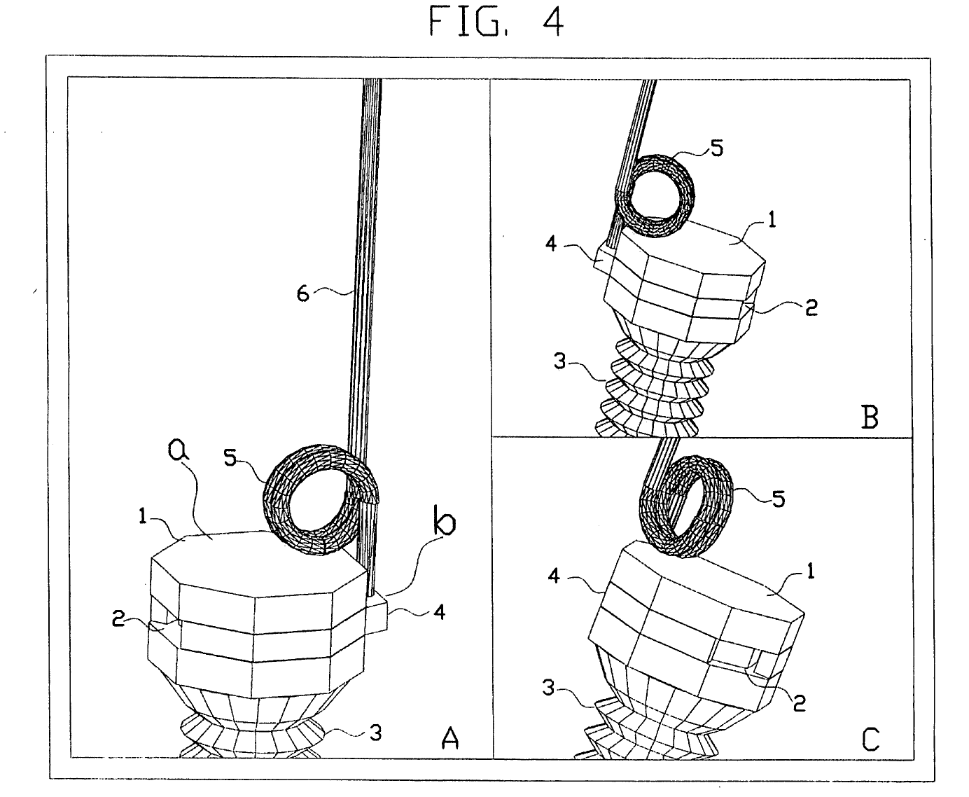

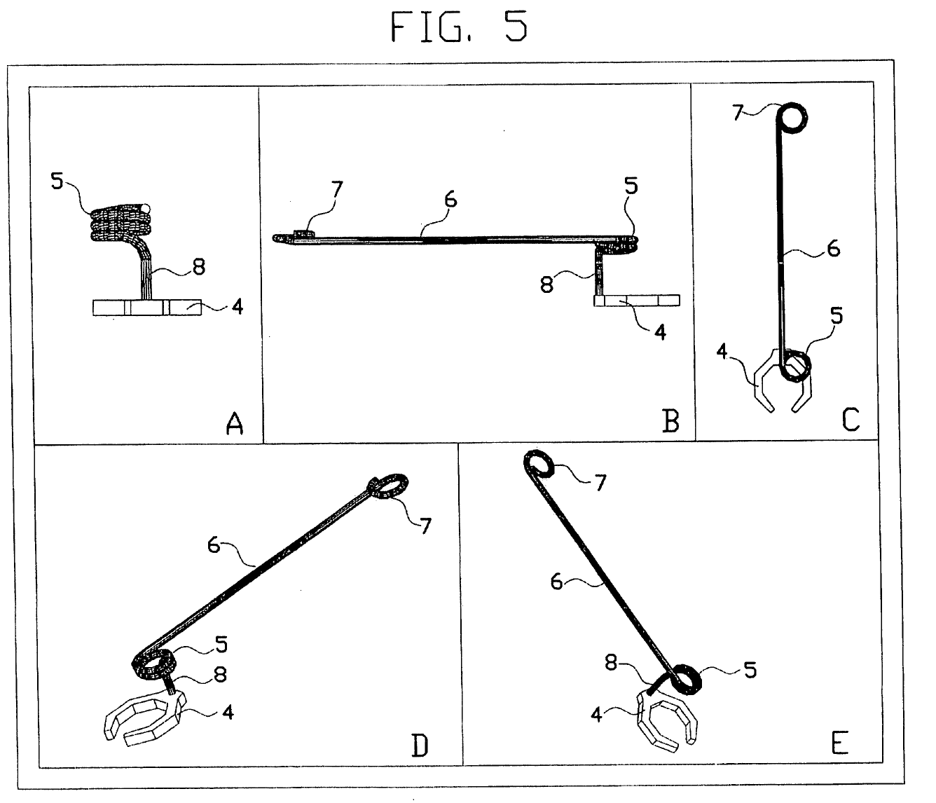

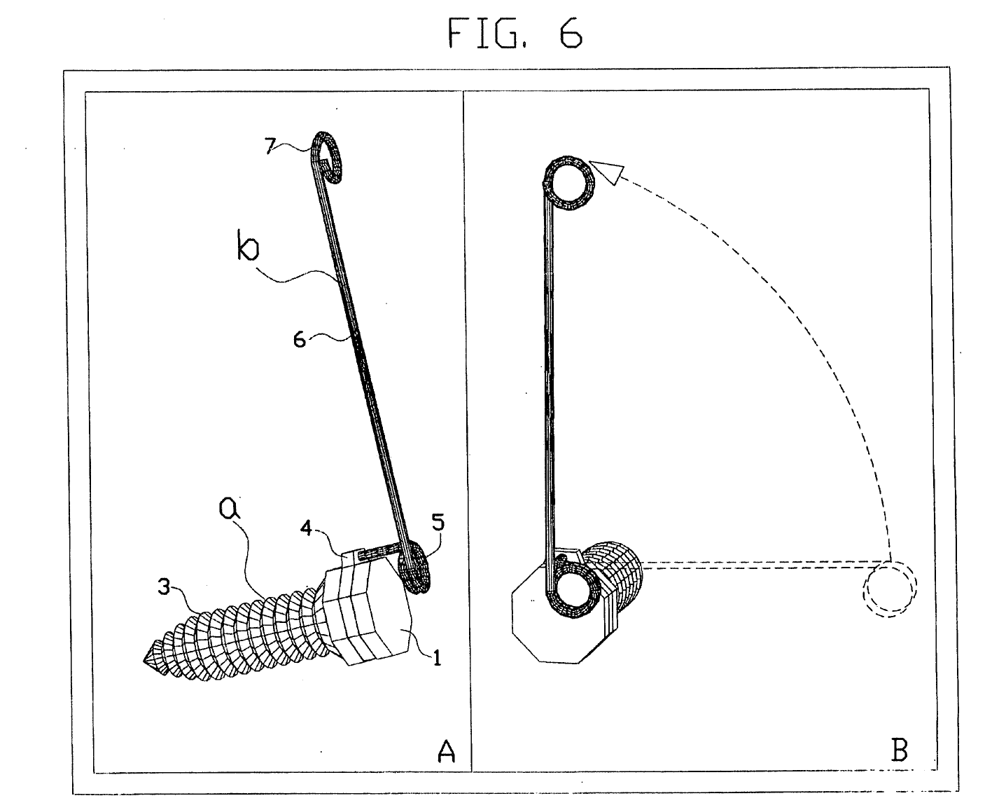

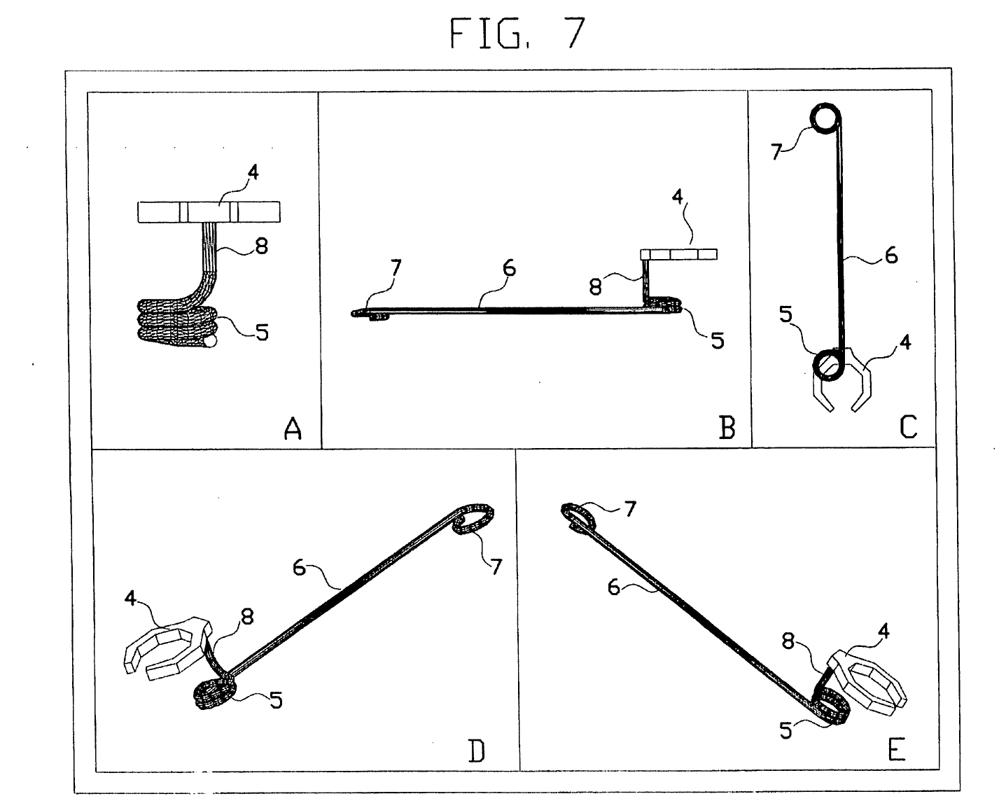

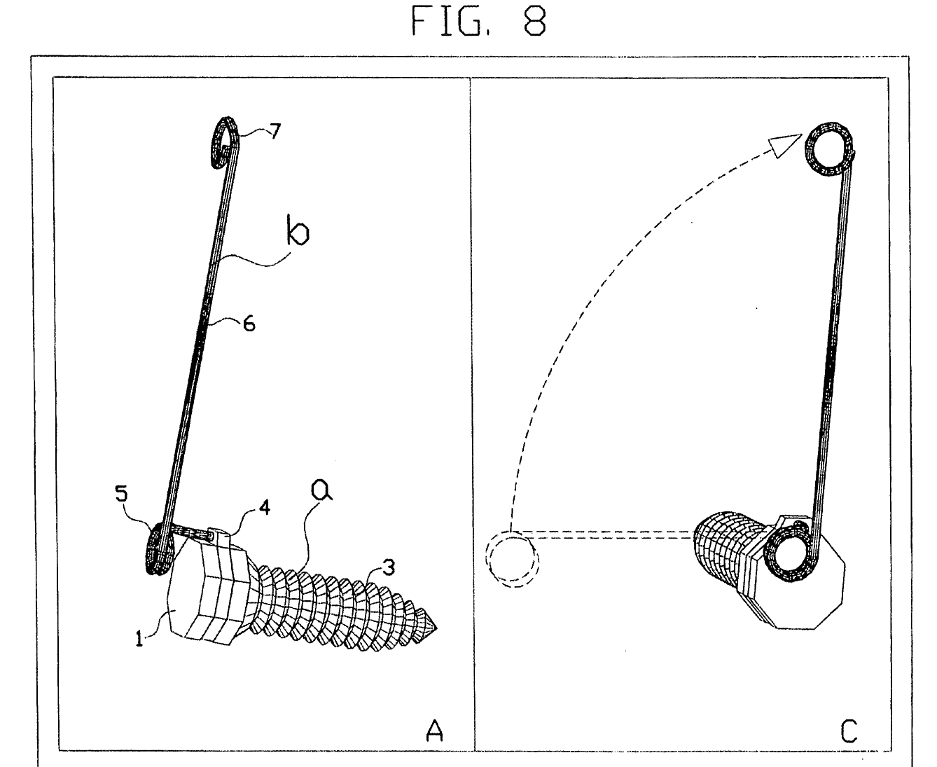

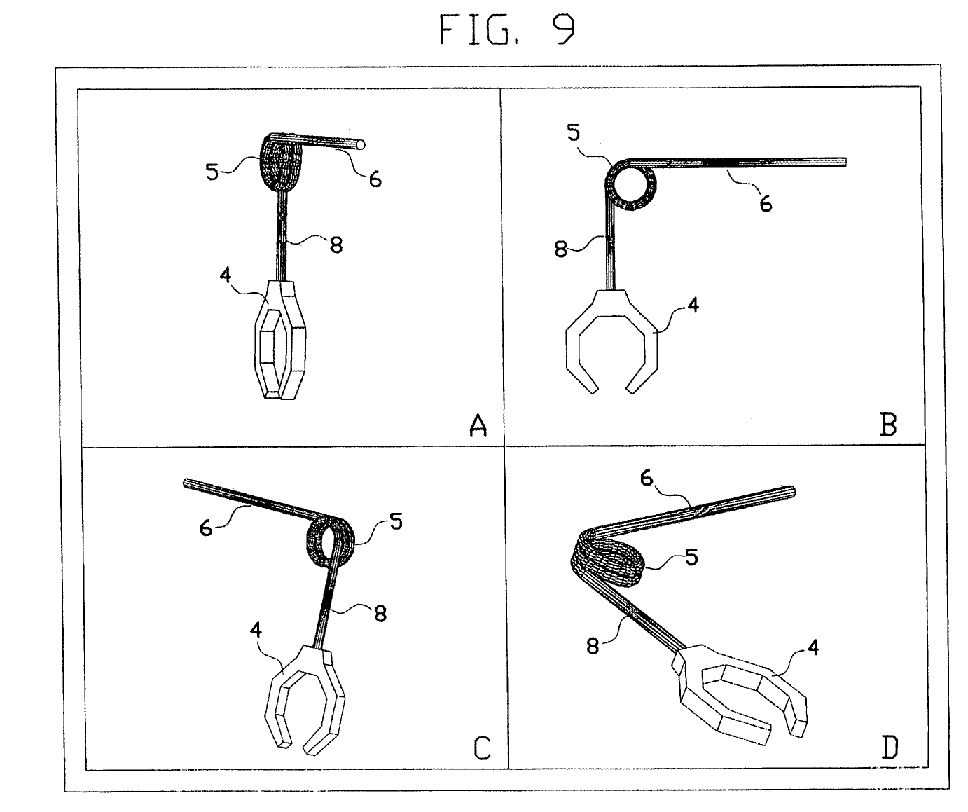

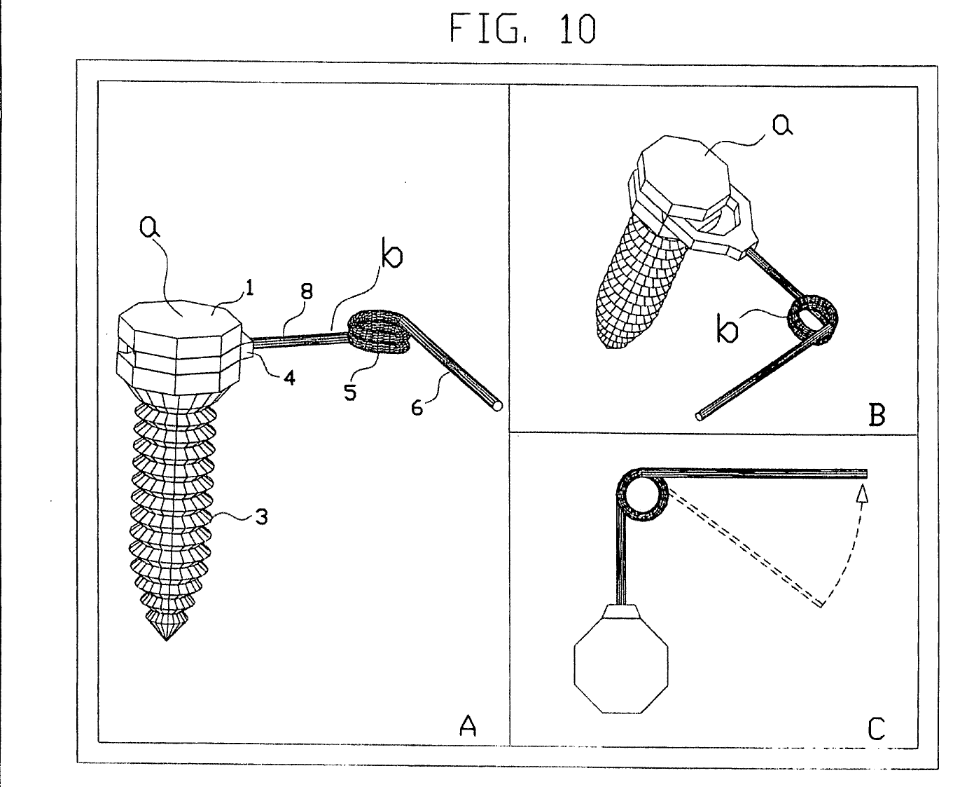

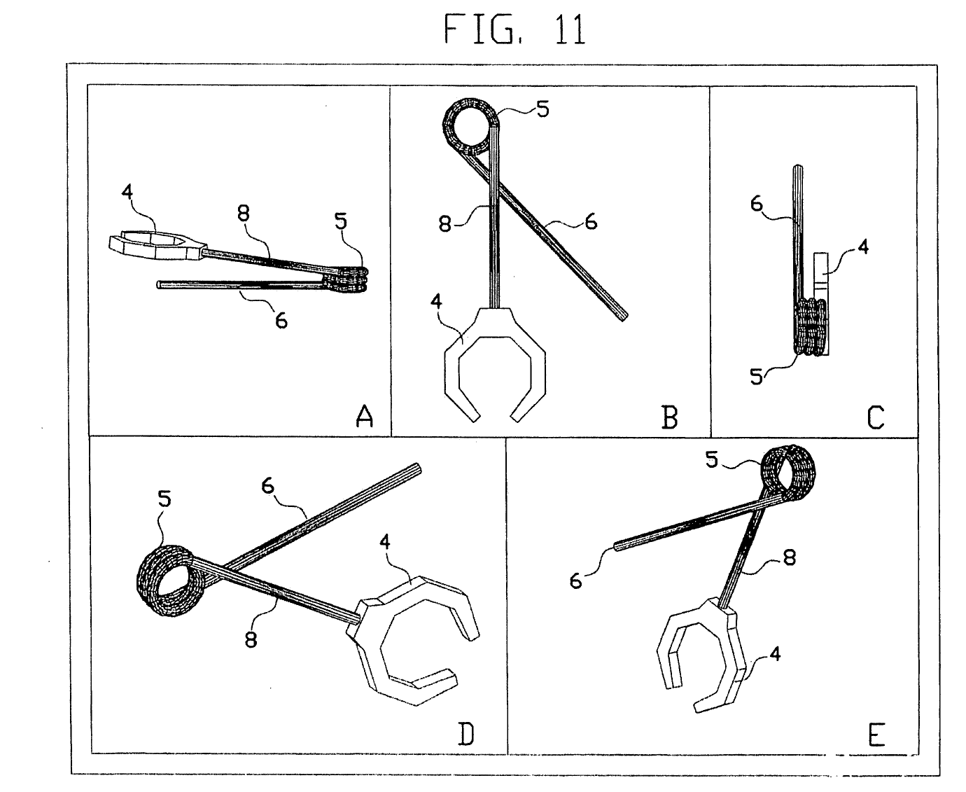

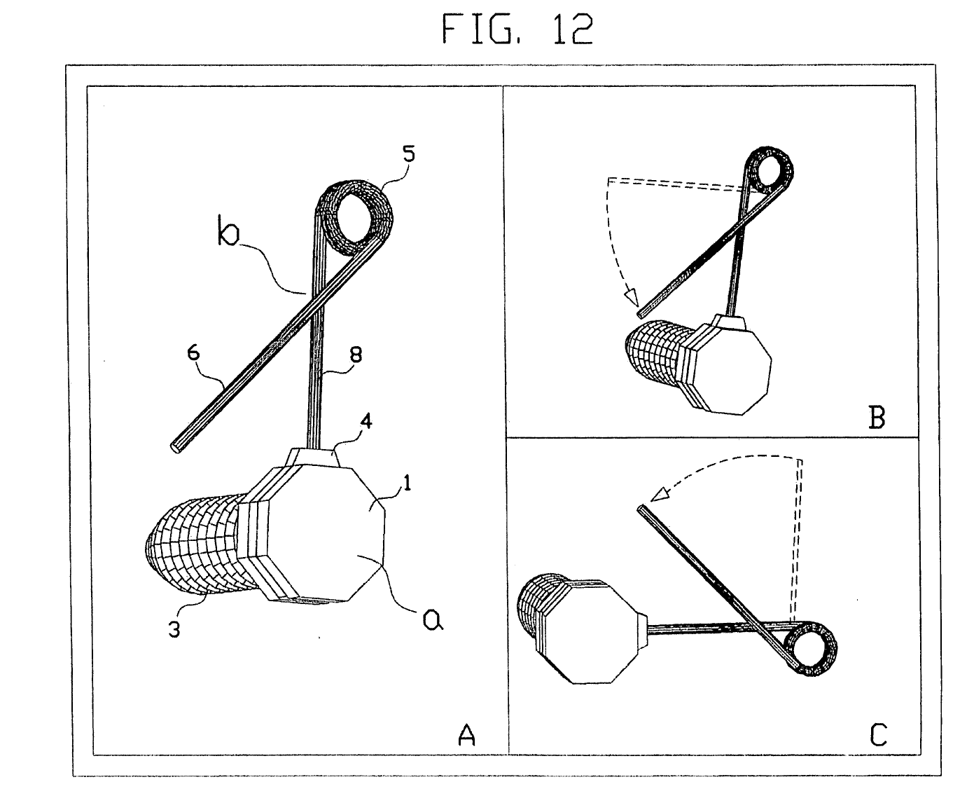

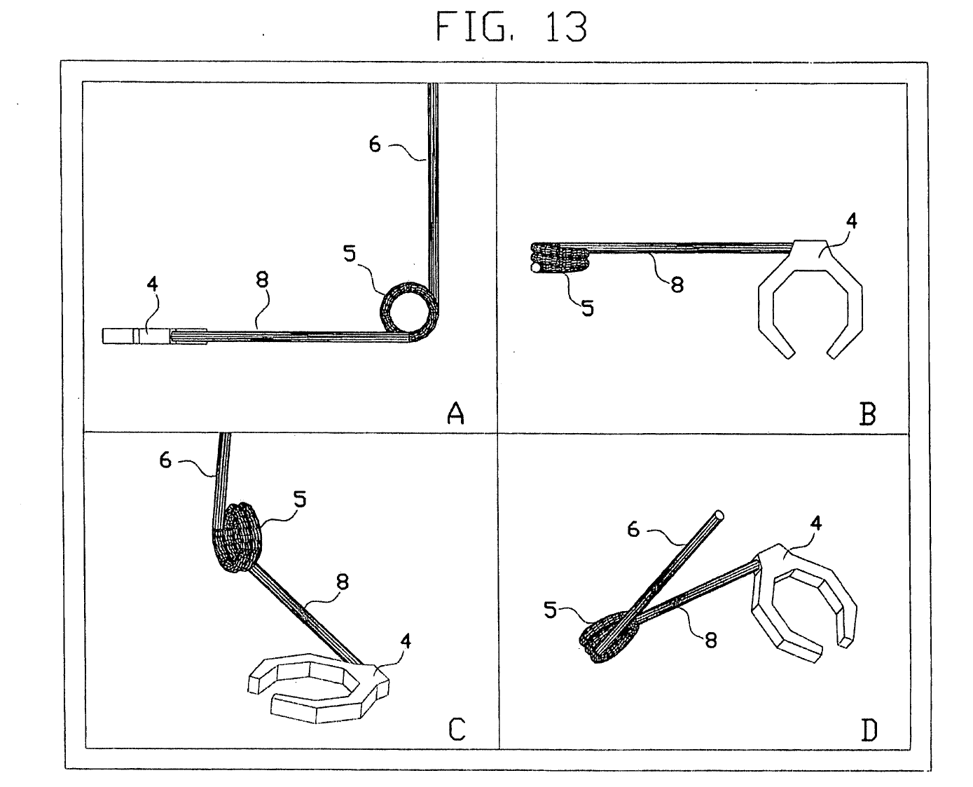

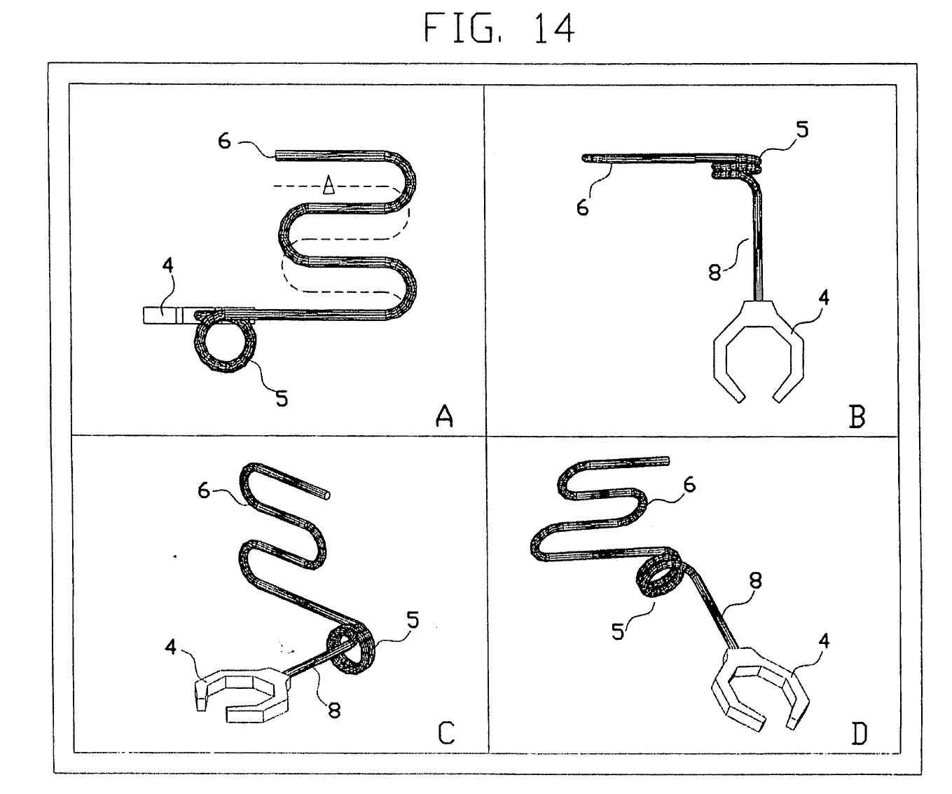

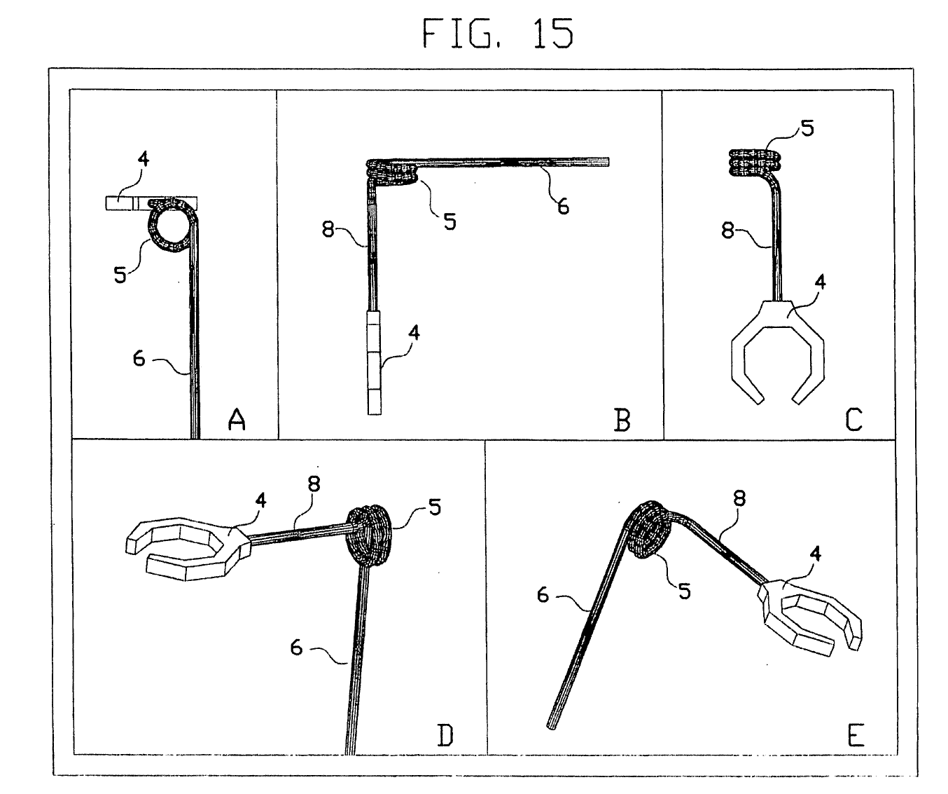

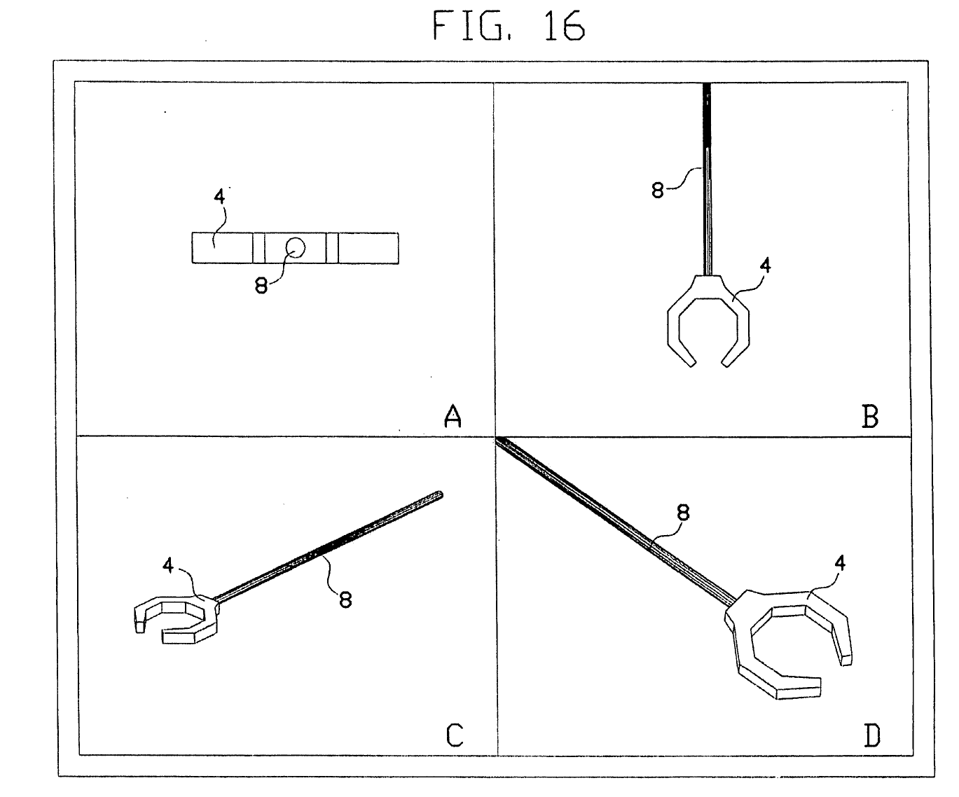

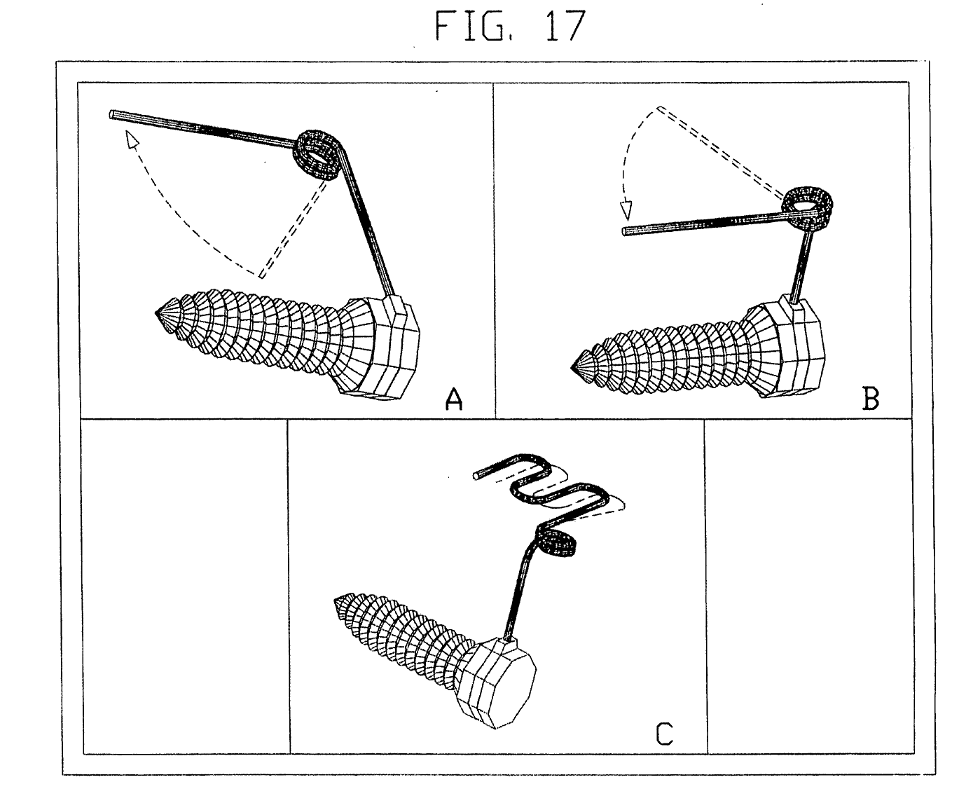

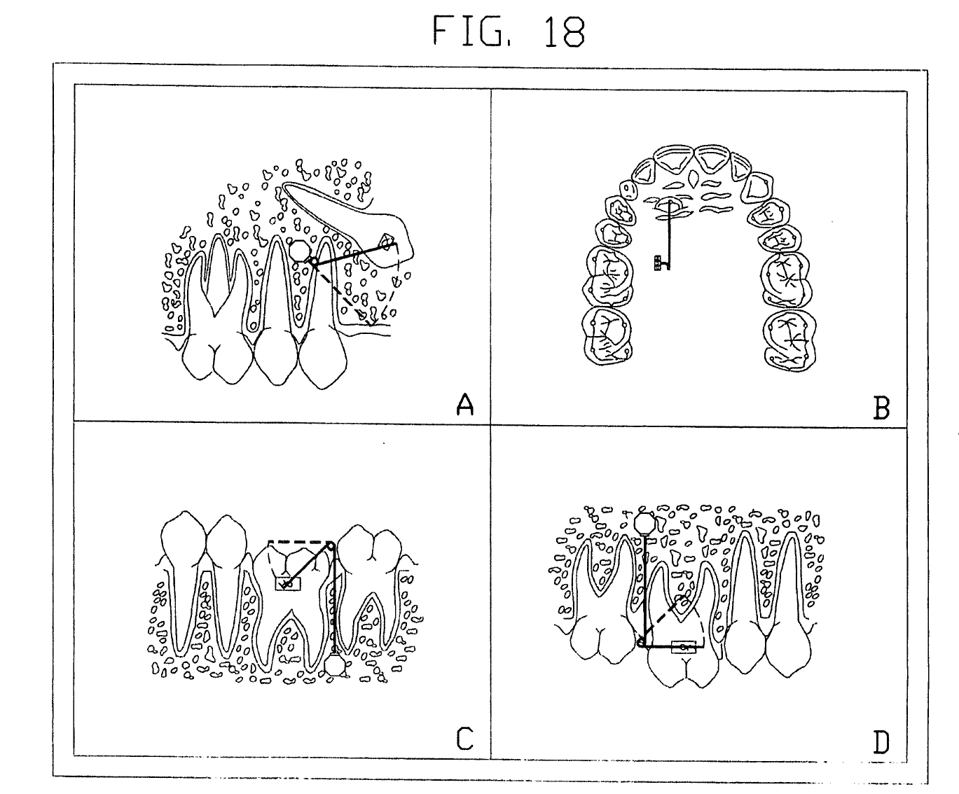

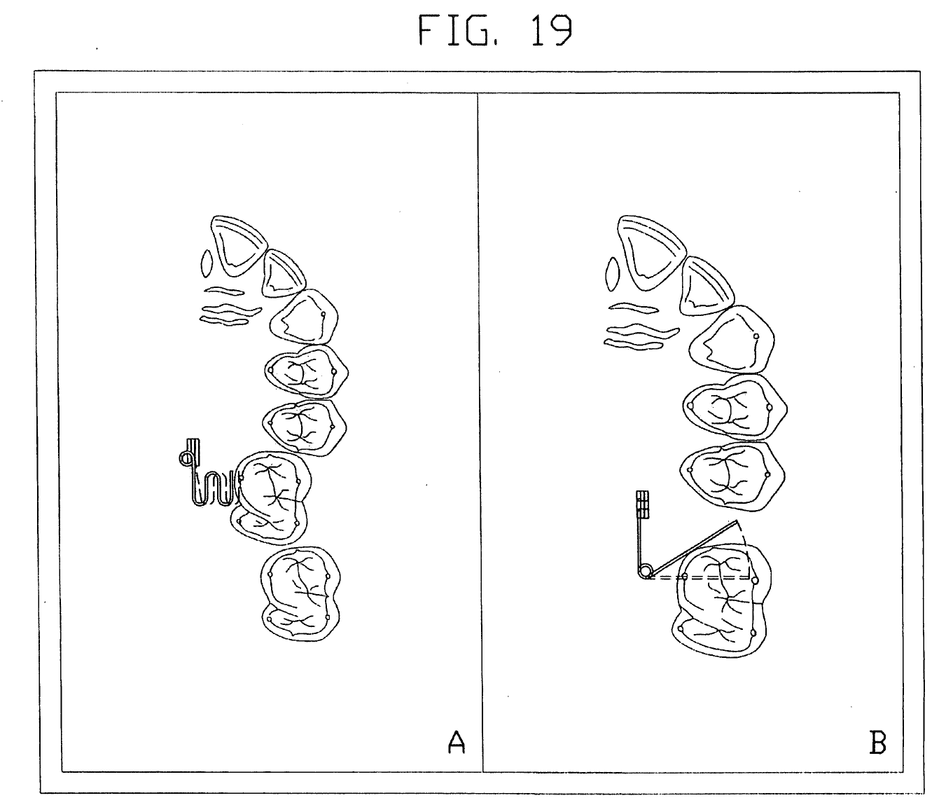

What is claimed is:

1. A device or system developed in order to do three dimensional tooth movements, getting anchorage on an Orthodontic Micro Implant specially designed to couple with the “C “clasp portion of this system. It is important to notice that in this invention not only there is an Orthodontic Micro Implant used as anchorage, but this one is specially designed to received as a couple, the part b or active part of such system which it is composed by an Spring attached to a “C” Clasp base which it will deliver the continuous force system we need in order to get teeth movements.

2. Process of setting the spring retained device into a specific Orthodontic Micro Implants created in conjunction with in order to create tooth movements.
The Orthodontic Micro Implant is set in place screwing it, having in mind a pre conscious correct position in order to the device or attachment (b) is inserted in the implant's head using the C clasp portion. Activation of the spring will be given following the desirable direction of tooth movement, extrusion, and intrusion, distal or mesial, labial or lingual movement as required.
A circle or helix is done at the end of the active part of the spring, 7, in order to be used as a connective portion with the tooth to be moved using a simple elastic ligature or a ligature wire as a connective material between both parts, depending in how long you want the active part to be.
